(19) United States
(12) Patent Application Publication
(10) Pub. No.: US 2014/0246385 A1
(43) Pub. Date: Sep. 4, 2014

(54) ENHANCED DEWATERING OF SLURRIES

(71) Applicant: RESIDUE SOLUTIONS PTY LTD., (US)

(72) Inventor: David Smirk, Chandler (AU)

(73) Assignee: RESIDUE SOLUTIONS PTY LTD., Chandler (AU)

(21) Appl. No.: 13/782,104

(22) Filed: Mar. 1, 2013

(51) Int. Cl. B01D 21/00; B01D 21/24; B01D 21/28

(52) U.S. Cl. CPC B01D 21/003; B01D 21/28; B01D 21/2444
USPC 210/770

(57) ABSTRACT

The present invention concerns a method to enhance the dewatering of a settling pond, said method including: identifying one or more parameters of the settling pond including initial slurry density, target slurry density, initial depth of slurry, and target depth of slurry; preparing the settling pond by dividing the settling pond into one or more sub areas; depositing a slurry into the sub areas to a depth equal to the target depth of slurry; allowing the deposited slurry to consolidate under gravity and release fluid; further consolidating the deposited slurry in each sub area with mechanical means adapted to provide low ground pressure; and repeating the further consolidating process periodically until the target slurry density is reached.

### TECHNICAL FIELD

The present invention concerns a method to enhance the dewatering of settling ponds, particularly tailings, slurries, soft soils, dredge spoils and the like.

### BACKGROUND

The reference to any prior art in this specification is not, and should not be taken as an acknowledgement or any form of suggestion that the prior art forms part of the common general knowledge.

Tailings, also called slimes, leach residue, or slickens (hereafter collectively referred to as “slurries”) are the waste materials left over after the mechanical and chemical processes are used to extract the desirable fraction from the non-desired fraction of a mined ore. Slurries, generally include ground rock and process effluents that are generated in the mine processing plant. The slurries are usually in a slurry form (a mixture of fine particles ranging from the size of a grain of sand to a few microns and fluid). Slurries sometimes also include process additives to enhance settling and consolidation.

In order to prevent the uncontrolled release of slurries into the environment, mines or other processing facilities usually have a disposal facility in the form of a tailings dam or pond (hereafter collectively referred to as “settling ponds”). This is a convenient method of storage because, as previously mentioned, the slurries are usually in the form of a slurry when they are discharged from the concentrator.

The integrity of a settling pond is one of the most important environmental issues for any mine during the project's life. In many instances, the slurry represent a significant environmental hazard containing, for example, uranium or other toxic heavy metals. Additionally some processing method utilise compounds such as copper sulfate, xanthate, hydrocarbons or cyanide, which will be present to some degree in the slurry and are hazardous to the environment. Several major environmental disasters have been caused by settling pond failures. However, damage to the environment can also occur without failure of a settling pond. This kind of damage is much less obvious and may take the form of acid drainage or dry slurry dust being blown away from the settling pond site.

Generally the lower the settled density of the slurry the greater the volume and area that is required to achieve safe and secure storage. This incurs a high capital cost to match the environmental risk. In some cases natural dewatering of slurries by consolidation and evaporation takes many months or even years. As these slurries have a low inherent strength they cannot be expanded or closed to allow commencement of rehabilitation.

Over the last century the volumes of slurry being generated has grown dramatically as the demand for minerals and metals has increased and lower and lower grades of ore are being mined. This is not surprising when considering that the volume of slurry requiring storage can often exceed the in-situ total volume of the ore being mined and processed. As such, many techniques have been employed to try and reduce the area required for effective slurry disposal or to increase the slurry load of an existing slurry disposal area. Generally all such techniques employed involve trying to improve the consolidation and dewatering of the slurry through the addition of flocculating compounds. That is, improvements are made before disposal operations occur.

Another technique to increase the capacity of a settling pond is called “upstream construction” which involves the construction of new parts of the embankment of a settling pond partially on top of existing slurry deposits impounded during a previous stage, thus the dam crest moves “upstream”. As the technique involves the construction over existing slurry deposits, foundation strength of the slurry deposits is critical to ensure the long-term integrity and stability of the growing embankment. One way to improve the foundation strength is through the effective dewatering of slurry deposits.

For the most part, the dewatering of slurries follows accepted and well understood processes. In general, these processes are:
drainage and self weight consolidation (decantation and underdrainage); and
evaporation.

The changing dynamics and influences of these processes are such that a failure to manage one of these processes will in all likelihood prevent effective dewatering due to the other processes. By managing these processes, a means of improving the dewatering characteristics of slurries can be achieved after disposal operations.

Thus, there is a need for an alternative method to enhance the dewatering of a settling pond.

### SUMMARY OF THE INVENTION

It is an object of the present invention to provide a method to enhance the dewatering of a settling pond which may overcome at least some of the abovementioned disadvantages, or provide a useful or commercial choice.

According to an aspect of the present invention, there is provided a method to enhance the dewatering of a settling pond, said method including:
(a) identifying one or more parameters of the settling pond, said one or more parameters selected from a group including one or more of initial slurry density, target slurry density, initial depth of slurry, and target depth of slurry;
(b) nominally dividing the settling pond into one or more sub areas;
(c) depositing a slurry into the sub areas to a depth equal to the target depth of slurry;
(d) allowing the slurry to consolidate under gravity and release fluid;
(e) further consolidating the slurry in each sub area with mechanical means; and
(f) repeating step (e) periodically until the target slurry density is reached.

In another aspect of the present invention, there is provided a method to enhance the dewatering of a settling pond, said method including:
(a) identifying one or more parameters of the settling pond, said one or more parameters selected from a group including one or more of initial slurry density, target slurry density, initial depth of slurry, target depth of slurry, and regional climatology;
(b) preparing the settling pond by:
   (i) nominally dividing the settling pond into one or more sub areas, each sub area having a slurry discharge point and a drainage collection point; and
   (ii) constructing a barrier at least partially around each sub area;
(c) depositing a slurry into the sub areas to a depth equal to the target depth of slurry;
(d) allowing the slurry to consolidate under gravity and release fluid;
(e) further consolidating the slurry in each sub area with mechanical means;
(f) repeating step (e) periodically until the target slurry density is reached: and
(g) monitoring the one or more parameters of the settling pond and repeating steps (c) to (f) as required.

Preferably, the barrier may be constructed to a height of at least 120% the target depth of slurry.

Preferably, step (b) further comprises the sub step of constructing one or more guidance barriers adjacent the slurry discharge point, said guidance barriers being adapted to guide a discharge of slurry from the slurry discharge point. Step (b) may also further comprise the sub step of placing one or more markers in the sub areas, said markers indicating the target depth of slurry.

Preferably, the slurry may be allowed to consolidate under gravity and release fluid in step (d) for between about 24 hours to about 72 hours.

In a preferred embodiment, the mechanical means of step (e) is adapted to provide low ground pressure. More preferably, the mechanical means comprises a vehicle adapted to plough and consolidate material over which it traverses.

Preferably, step (e) further comprises the sub steps of:
(i) constructing one or more drainage barriers adjacent the drainage collection point, said drainage barrier being adapted to collect nm-off slurry and fluid released from the slurry;
(ii) ploughing the slurry in a path from the drainage collection point to the slurry discharge point;
(iii) re-ploughing the slurry along said path from the slurry discharge point to the drainage collection point;
(iv) repeating sub steps (i) and (ii) about one vehicle width from said path; and
(v) repeating sub steps (i) to (iii) across each sub area; and
(vi) draining the fluid collected by the drainage barriers, and

wherein each sub area is ploughed at an even speed.

Preferably, step (f) comprises repeating step (e) about 2 to about 5 days until the target slurry density is reached.

In an embodiment of the present invention, a method is provided that provides the potential to increase the final density of deposited slurry enabling more slurry to be deposited in a settling pond, thereby reducing the area required for effective slurry disposal. The method also provides the potential to increase the foundation strength of existing slurry deposits thus providing a better foundation for increasing the capacity of an existing settling pond through techniques such as upstream construction. Additional secondary advantages provided are:
denser slurry deposits reduce the environmental risk of a settling pond failure by, for instance, seismic activity;
dewatered slurry can be used as construction material in, for instance, upstream construction; and
reduced operational areas and a more even drying process reduce the risk of settling pond dust generation as precipitates formed at the surface are further consolidated by mechanical means into the drying slurry, and the mechanical means creates a surface roughness reducing the potential for dust lift off.

As used herein the term “settling pond” refers to any reservoir open to the atmosphere and collect slurry-like material. The term encompasses tailings dams, waterlogged marshes and the like.

As used herein the term “slurry” and variations such as “slurries” refer to tailings, slimes, leach residues, slickens and other like waste material left over after the mechanical and chemical processes mineral extraction processes. The term encompasses any material with slurry-like properties.

As used herein the term “drainage collection point” refers to the low point in a sub area or operational area designated to collect run-off fluid.

As used herein the term “slurry discharge point” refer to the location in a sub area or operational area from which slurry is discharged.

As used herein the term “top of the sub area” refers to an edge of a sub area or operational area adjacent the slurry discharge point.

As used herein the term “bottom of the sub area” refers to an edge of a sub area or operational area opposite the top of the sub area, the edge being adjacent the drainage collection point.

In one embodiment of the present invention, step (a) of the method may involve the identification of one or more parameters of the settling pond. The method may involve the identification of further parameters such as regional climatology and settling pond personnel operation parameters such as shift rosters. Preferably, the method involves: the identification of one or more parameters of the slurry including initial slurry density, target slurry density, initial depth of slurry, target depth of slurry, specific gravity, vertical permeability of the saturated slurry, and variability in slurry initial viscosity; identification of one or more parameters of the settling pond including area of operation, angles of repose, locations of slurry discharge points, locations of drainage collection points and drainage structures; and identification of one or more parameters of the regional climatology including median rainfall, median evaporation and the relationship between pan evaporation and lake evaporation.

Upon identifying the key parameters, the method according to a preferred embodiment of the present invention may then involve step (b), the preparation of the settling pond. This may involve nominally dividing the settling pond into one or more operational sub areas. The number of sub areas chosen may be dependent upon the size of the settling pond. The number of sub areas chosen may then be used to develop a schedule of operations. Typically, a settling pond on average is divided into approximately twenty sub areas.

In a preferred embodiment, each sub area may have an associated slurry discharge point and drainage collection point. The identification of the slurry discharge point and drainage collection point in each sub area establishes an operational axis (the line between the slurry discharge point and the drainage collection point).

In dividing the settling pond into a variable number of sub areas, consideration may be given to: the ability to access stranded equipment should the need arise (i.e., the sub areas should not be too wide).

In an embodiment of the present invention, a barrier may be constructed to extend at least partially around each sub area. The barrier may be of any suitable size, shape or configuration and constructed from any suitable material adapted to separate one sub area and the contents thereof from adjacent sub areas. The barriers may be engineered structures. Preferably, however, the barrier will be prepared from earth materials or previously dewatered slurry. Typically, the barriers will only be constructed for sub areas with variable slurry characteristics and may be negated for sub areas with minimal variability in slurry characteristics. The barriers may be prepared using any suitable means. Typically, the barrier may be prepared using mechanical means. Preferably, the height of the barrier will be approximately 120% of the planned depth of slurry.

Preferably, markers may be placed in each sub area. The markers may be of any suitable size, shape or construction adapted to indicate the target depth of slurry. The markers may be natural markers (i.e., rocks or logs left over from cleared land). Preferably, the markers will be sacrificial. In a preferred embodiment, markers may be placed every 100 m on either side of each sub area.

According to a preferred embodiment of the present invention, step (c) of the method involves depositing a slurry into the sub areas to a depth equal to the target depth of slurry. The slurry may be deposited into each sub area via the associated slurry discharge point. Preferably, the deposition of slurry should cease when the slurry front is approximately 25 m from the bottom of the sub area. This is to account for the momentum present in the slurry as the rate of flow of slurry slows.

Depending on the density and viscosity of the slurry, one or more guidance barriers may be constructed adjacent the slurry discharge point, said guidance barriers being adapted to guide the discharge of slurry from the slurry discharge point. The guidance barriers may be of any suitable size, shape or configuration and may be constructed from any suitable materials. The guidance barriers may be engineered structures. Preferably, the guidance barriers will be sacrificial structures. In a preferred embodiment, the guidance barriers may be formed from earth materials or previously dewatered slurry materials.

Once a slurry is deposited into the sub areas, the deposited slurry under step (d) may be allowed to consolidate under gravity and release fluid. Preferably, the released fluid may then drain via the drainage collection point. The slurry may continue to drain fluid until the slurry reaches “field capacity” or a density at which excess fluid will stop being shed by consolidating forces at a rate equal to the vertical permeability of the slurry. The “field capacity” is variable depending on the properties of the slurry. Typically, a slurry is allowed to consolidate for between about 24 to about 72 hours.

Upon allowing the deposited slurry to consolidate, in accordance with step (e) further consolidation of the deposited slurry in each sub area may be undertaken with mechanical means, preferably adapted to provide low ground pressure. The mechanical means may be of any suitable size, shape or construction suitably adapted to further consolidate the deposited slurry by ploughing the deposited slurry. Preferably, the mechanical means is a vehicle. Most preferably, the mechanical means is a Twin Archimedes Screw Tractor adapted to consolidate and dewater materials over which it traverses, commonly referred to as a MudMaster™ (Residue Solutions Pty Ltd; http://www.residuesolutions.com.au).

In a preferred embodiment, step (e) involves:
(i) ploughing the slurry in a path from the drainage collection point to the slurry discharge point;
(ii) re-ploughing the slurry along the path of sub step (i) from the slurry discharge point to the drainage collection point;
(iii) repeating sub steps (i) and (ii) about one vehicle width from said path; and
(iv) repeating sub steps (i) to (iii) across each sub area.

The initial ploughing of a slurry may commence at any location in a sub area. However, preferably, ploughing may commence at the edge of a sub area and continue in an uninterrupted straight line to the top of a sub area (i.e., the end at which the slurry discharge point is located). Ploughing should preferably occur at an even speed and without stopping until the vehicle reaches the top end of the sub area. Stopping of the vehicle prior to reaching the top end may result in a situation where the slurry will envelop the vehicle making further progress difficult. Additionally, stopping places additional stress on the foundation layers and can lead to bogging on restart due to the large force required to commence movement.

The initial plough may liberate a large amount of fluid, which will then collect at the drainage collection point at the bottom of the sub area. Depending on the characteristics of each sub area it may be necessary to construct one or more drainage barriers adapted to collect run-off slurry and fluid released by the deposited slurry. The drainage barrier may be of any suitable size, shape or configuration and may be constructed out of any suitable material. The drainage barrier may be an engineered structure. Preferably, the drainage barrier will be constructed from earth materials or previously dewatered slurry material.

Fluid that is collected by the one or more drainage barriers may be allowed to drain. The collected fluid may be allowed to drain by breaching the one more drainage barriers. Preferably, the breached drainage barriers are rebuilt prior to further ploughing. An additional advantage of preparing for the one more drainage barriers is that they provide a means of stilling released fluid to allow suspended slurry material to settle out thereby minimising the impact of suspended slurry on liquid management systems.

Once released fluid has ceased collecting at the one or more drainage barriers and the collected fluid has been drained, in accordance with step (f) further ploughing may commence. Typically, further consolidation of the slurry in accordance with step (f) may occur about two to about five days after the previous plough. As before, the ploughing preferably should commence from the bottom of each sub area to the top of each sub area. Further ploughing may be undertaken between the previous plough lines thereby ploughing untouched slurry deposit areas.

Once the entire sub area has been re-ploughed, additional fluid will be released and collect at the one or more drainage barriers. As with after the previous plough, the collected fluid should be drained.

Typically and in accordance with step (f), step (e) is repeated until the target slurry density is reached. Ideally, when further consolidation results in a smooth slurry surface and the tracking of the vehicle leaves indentations of less than 10 mm the slurry may be considered to be completely dewatered and the sub area can be prepared for a further slurry deposit.

Typically, routine measurements are made to identify when the target slurry density is reached. Measurements may be made using any suitable means. Preferably measurements may be made using a hand-held shear vane shear tester together with routine slurry coring to develop a density/shear strength curve. Once sufficient measurements have been made the shear vane measurements may be used to infer the slurry density. An advantage of taking routine measurements are that rapid density determinations may be made thus allowing the forecasting of future slurry deposition schedules.

In parallel with the consolidation process, fluid may also be removed by evaporation. The evaporative drying of slurries tends to follow the classic three stage drying process. In a slurry environment these stages are evident as the deposited slurry initially simulates a free water surface. In the absence of an external energy source, the potential evaporation rate determined by ambient climate conditions is the maximum possible evaporation rate. This stage will continue at close to the potential evaporation rate until the available fluid content is decreased and the rate of evaporation is then controlled by the liquid transfer properties of the slurry. The third stage commences when the reduction in fluid content reduces evaporative loss to the rate of vapour transfer between fluid droplets held in the interstitial voids in the slurry. A key difference when comparing the drying of slurry to the drying of the soil is that the removal of fluid by evaporation from the entrained fluid will result in the accumulation of precipitated impurities. This tends to create a desiccated layer on the surface of the slurry further reducing the evaporation rate.

The limiting issue in evaporative drying is not the potential evaporation rate but the area over which it is acting. By routinely ploughing a drying slurry, fresh moist surfaces are exposed and the surface area increases significantly as opposed to a flat surface. In addition, by repeatedly turning over the slurry, any fluid impurities precipitated at the evaporative surface are recombined with the slurry and have limited impact on the drying rate. It is thus possible to maintain a very high net evaporative loss even as the net evaporation rate decreases.

The actual evaporation rate is dependent on the properties of the slurry and is measured rather than predicted.

As the consolidation process is repeated, dewatering of the slurry leads to higher densities and strengths. Within the slurry this imparts a characteristic where the slurry progressively changes from a uniform slurry to a crumbling solid. Initially the passage of the vehicle results in minimal impact to the slurry other than a slight indentation along the plough lines that act as a drain removing fluid and rainfall run-off. After repeated ploughing the plough lines will begin to remain open. This process progressively results in an expansion of the evaporating surface area. At its maximum extent this can increase up to about 57% (not including the increase in evaporating surface due to the crumbling of the slurry solids). This, in part, compensates for the reduction in the evaporation rate (particularly when the slurry moves to the third stage of evaporation) resulting in a near constant rate of evaporative loss and a more rapid dewatering process.

In yet another aspect of the present invention, there is provided a method to improve the foundation of a portion of a settling pond by enhancing the dewatering of the portion of the settling pond, said method including:
(a) identifying one or more parameters of the portion of the settling pond in need of improved foundations including target slurry density;
(b) consolidating the portion with one or more mechanical means; and
(c) repeating step (b) until the target slurry density is reached.

In step (a) of the method, one more parameters may be identified using any suitable means known to a person skilled in the art. The one or more parameters identified include the target slurry density and may additionally include identifying the portion of the settling pond requiring foundation improvement including access and drainage restrictions from the adjacent wall portions of the portion of the settling pond.

Under step (b), consolidation of the portion by ploughing the portion with the one or more mechanical means may commence from any location in the portion and may be of any particular path suitably adapted to create a surface drain to direct released fluid from the consolidated portion to the drainage collection point. Typically, the one or more mechanical means are one or more vehicles adapted to provide low ground pressure. Preferably, the one or more mechanical means may commence consolidation of the portion by:
(i) ploughing a path in the portion approximately 50 m in length, or as far as possible, in a direction approximately 45 degrees from an edge of the portion;
(ii) re-ploughing said path in the reverse direction;
(iii) repeating sub steps (i) and (ii) about one path width from the initial path; and
(iv) repeating sub steps (i) to (iii) along the edge.

By repeating sub steps (i) to (iii), above, a “herringbone-like” surface drainage pattern is ploughed into the portion, which may direct the drainage of released fluid into the centre of the portion, away from the edge.

A low ground pressure vehicle may be tracked across a long the edge of the portion to ensure that unimpeded drainage occurs along the plough paths of the portion adjacent the edge will become disturbed due to the routine changing of direction of the one or more vehicles.

Under step (c), once the entire portion has been ploughed along the edge, the portion may be further consolidated by re-ploughing the initial plough path thereby deepening previously plough paths and then, if the target density is not reached, splitting the previous plough paths by ploughing between the previously ploughed paths.

If necessary, the length of the plough path can be extended to increase the width of the foundation footprint, primarily to start foundation development further out away from the edge.

In a preferred embodiment, slurry density is periodically monitored throughout steps (a) to (c).

Initially there is practically no vane shear strength measurable. This means that dewatering activity will need to be maintained even though there will be no changes in shear strength detected. As a result, initial monitoring will concentrate on visual changes to the slurry surface. These changes will occur due to the dewatering process and are manifested by the movement of the fluid from the slurry. The key changes that may be initially observed include:
evidence that plough paths are starting to remain in place and do not collapse after the one or more vehicles have passed;
the location/volume of fluid released;
weather condition and local impacts;
the drainage pathways from released fluid and rainfall run-off;
evidence of carbonation or crystallisation of salts from the released fluid;
operator feedback on machine effort, ride height and directional tracking to ascertain underlying slurry consistency; and
operation of any surface drainage pumping.

To accommodate these observations a layered monitoring approach may be required. This may include:
daily photography of the operational area;
weekly vane shear measurements taken every one hundred metres approximately midway a long the plough path of the one or more vehicles; and
fortnightly surveying of the foundation area as access permits.

In yet a further aspect of the present invention, there is provided a method to enhance the dewatering of a settling pond, said method including:
(a) identifying one or more parameters of the settling pond, said one or more parameters selected from a group including one or more of initial slurry density, target slurry density, initial depth of slurry, target depth of slurry, and regional climatology;
(b) preparing the settling pond by:
   (i) nominally dividing the settling pond into one or more sub areas, each sub area having a slurry discharge point and a drainage collection point;
   (ii) constructing a barrier at least partially around each sub area to a height at least 120% the target depth of slurry;
   (iii) constructing one or more guidance barriers adjacent the slurry discharge point, said guidance barriers adapted to guide a discharge of slurry from the slurry discharge point; and
   (iv) placement of one or more markers in the sub areas, said markers indicating the target depth of slurry;
(c) depositing a slurry into the sub areas to a depth equal to the target depth of slurry;
(d) allowing the slurry to consolidate under gravity and release fluid for between about 24 hours to about 72 hours;
(e) further consolidating the slurry in each sub area with mechanical means adapted to provide low ground pressure, wherein said mechanical means is a vehicle adapted to plough the slurry, and wherein the slurry is further consolidated by:
   (i) constructing one or more drainage barriers adjacent the drainage collection point, said drainage barrier adapted to collect run-off slurry and fluid released from the slurry;
   (ii) ploughing the slurry in a path from the drainage collection point to the slurry discharge point;
   (iii) re-ploughing the slurry along said path from the slurry discharge point to the drainage collection point;
   (iv) repeating sub steps (i) and (ii) about one vehicle width from said path; and
   (v) repeating sub steps (i) to (iii) across each sub area, and
   (vi) draining the fluid collected by the drainage barriers, and wherein each sub area is ploughed at an even speed:
(f) repeating step (e) periodically until the target slurry density is reached, wherein periodically is about every 2 to about 5 days; and
(g) monitoring the one or more parameters of the settling pond and repeating steps (c) to (f) as required.

### BRIEF DESCRIPTION OF THE DRAWINGS

Preferred features, embodiments and variations of the invention may be discerned from the following Best Modes Of Carrying Out The Invention which provides sufficient information for a skilled addressee to perform the invention. The Best Modes Of Carrying Out The Invention is not to be regarded as limiting the scope of the preceding Summary Of The Invention in an way. The Best Modes will make reference to the following drawing:

FIG. 1 is a diagram of a consolidation pattern of a method of the invention according to a preferred embodiment.

### BEST MODES OF CARRYING OUT THE INVENTION

### Example 1

### A Method to Enhance the Dewatering of a Settling Pond

This example describes a method to enhance the dewatering of a settling pond according to an embodiment of the present invention.

Step 1

One or more parameters of a settling pond including the initial slurry density, target slurry density, initial depth of slurry, target depth of slurry, location of slurry discharge points, drainage collection points, angle of repose and regional climatology are identified.

Step 2

The settling pond is then prepared by dividing the settling pond into one or more sub areas. Each sub area having a slurry discharge point and drainage collection point. Depending on the characteristics of the slurry, constructing a barrier formed from earth materials or dewatered slurry (if available) at least partially around each sub area. The barrier being constructed to a height at least 120% the target depth of slurry.

If needed, depending on the characteristics of the slurry, constructing one or more guidance barriers adjacent the slurry discharge point for each sub area from earth materials or dewatered slurry (if available) to guide the discharge of slurry into each sub area.

The placement of one or more sacrificial markers in each sub area indicating the target depth of slurry.

Step 3

Depositing slurry via the slurry discharge point into each sub area to a depth equal to the target depth of slurry. Ceasing the deposition of slurry into each sub area when the front of the deposited slurry is approximately 25 m from the bottom of the sub area to account for the residual momentum of the deposited slurry.

Step 4

Allowing the deposited slurry to consolidate under self-weight and gravity and release fluid for typically between about 24 hours to about 72 hours. The deposited slurry will continue to release fluid until the deposited slurry reaches “field capacity” or a density at which fluid will stop being released by the consolidating forces at a rate equal to the vertical permeability of the slurry.

Step 5

Further consolidation of the deposited slurry in each sub area commences once there is no more fluid being released by the deposited slurry. Further consolidation is undertaken with a vehicle adapted to provide low ground pressure (i.e., mechanical means). The vehicle being adapted to plough or turn over the upper layer of the deposited slurry. The vehicle ideally will be a Twin Archimedes Screw Tractor specifically adapted to consolidate and dewater the materials over which it traverses, commonly referred to as a MudMaster™ (Residue Solutions Pty Ltd: http://www.residuesolutions.com.au).

Prior to commencing to plough each sub area, one or more earthen drainage barriers should be constructed at the bottom end of each sub area, the end opposite the slurry discharge point and adjacent the drainage collection point. The drainage barriers should be constructed from earth materials or dewatered slurry (if available) and be constructed in such a manner as to collect fluid released from the consolidated slurry and any run-off rain or slurry.

The deposited slurry should be initially ploughed in a direct path from the bottom end where the drainage collection point is located to the top end where the slurry discharge point is located. Once the vehicle reaches the top end, the vehicle turns around ploughs a fresh path toward the bottom end approximately one vehicle's width (˜4 m) from the initial plough path. This process is repeated until the whole sub area has been ploughed.

When ploughing it is important a constant speed is maintained and that the vehicle only ever stops at the top end of the sub area. This ensures the vehicle does not bog in the slurry.

A large amount of fluid, often called “bleed” water, will be released by the further consolidation of the deposited slurry. This released fluid is allowed to collect in the one or more drainage barriers. Prior to commencing further ploughing this collected fluid should be drained by simply breaching the drainage barriers with for instance a swamp excavator. The drainage barriers are repaired prior to further ploughing.

Step 6

Step 5 is then repeated along the same plough paths or by splitting the previously ploughed paths by ploughing between the previous plough paths. The shiny density is periodically measured to monitor when target slurry density is reached. The slurry density is measured by

using a hand-held shear vane shear tester together with routine slurry coring to develop a density/shear strength curve. Once sufficient measurements have been made the shear vane measurements can be used to infer the slurry density.

### Example 2

### A Method to Improve the Foundation of a Portion of a Settling Pond

This example describes a method to improve the foundation of a portion of a settling pond according to an embodiment of the present invention.

Step 1

Identifying one or more parameters of the portion of the settling pond as outlined in Step 1 of Example 1, above, including identifying the portion of the settling pond in need of improved foundations and the target slurry density.

Step 2

Consolidating the portion with a vehicle (i.e., mechanical means) as indicated in Step 5 of Example 1, above.

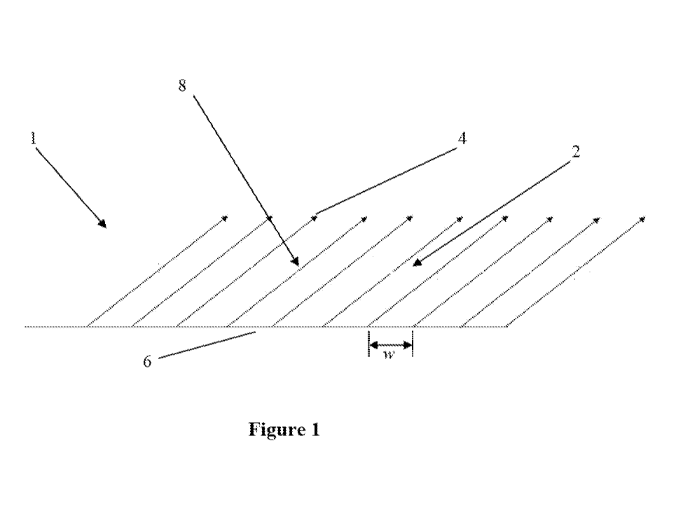

Referring to FIG. 1, the consolidation of the portion 2 of the settling pond 1 comprises the process of ploughing a path 4 approximately 50 m in length (or as far as possible) in a direction approximately 45 degrees from an edge 6 of the portion 2. The vehicle then re-plough the same path in the reverse direction (i.e., back towards the edge). This process is then repeated approximately one plough width (w; i.e., approximately 4 m) along the edge 6 until the entire edge 6 of the portion 2 has been ploughed.

As a result of the consolidation process a “herringbone-like” surface drainage pattern 8 is formed, which is adapted to drain fluid released from the consolidation of the slurry along the plough paths 4 away from the edge 6 of the portion 2.

A low ground pressure swamp excavator can be used to track across the portion 2 adjacent the edge 6 to ensure that unimpeded drainage occurs along the plough paths 4, which will have a propensity to be disturbed by the continual changing in direction of the vehicle.

Step 3

Step 2 is then repeated to re-plough the same plough paths thereby deepening the plough paths. As with Example 1, the slurry density is periodically measured to monitor when target slurry density is reached. Depending on how far away from the edge 6 the portion 2 of the settling pond 1 is located in need of improved foundations, the initial plough paths of Step 1 can be extended further away from the edge 6.

If the target slurry density is not reached, the previously re-ploughed paths are then split by ploughing between the previously ploughed paths. Step 3 is repeated until the target slurry density is reached.

A skilled addressee will appreciate that many embodiments and variations can be made without departing from the ambit of the present invention.

In compliance with the statute, the invention has been described in language more or less specific to structural of methodical features. It is to be understood that the invention is not limited to specific features shown or described since the means herein described comprises preferred forms of putting the invention into effect.

Throughout the specification and claims, unless the context requires otherwise, the term “comprise”, or variations such as “comprises” or “comprising”, will be understood to apply the inclusion of the stated integer or groups of integers but not the exclusion of any other integer or group of integers.

1. A method to enhance the dewatering of a settling pond, said method including:
(a) identifying one or more parameters of the settling pond, said one or more parameters selected from a group including one or more of initial slurry density, target slurry density, initial depth of slurry, and target depth of slurry;
(b) nominally dividing the settling pond into one or more sub areas;
(c) depositing a slurry into the sub areas to a depth equal to the target depth of slurry;
(d) allowing the slurry to consolidate under gravity and release fluid;
(e) further consolidating the slurry in each sub area with mechanical means; and
(f) repeating step (e) periodically until the target slurry density is reached.

2. The method of claim 1, wherein each sub area has a slurry discharge point from where the slurry is deposited into each sub area and a drainage collection point where the fluid released from the deposited slurry collects.

3. The method of claim 1, wherein the mechanical means is a vehicle adapted to further consolidate the deposited slurry by ploughing the deposited slurry.

4. The method of claims 3, wherein step (e) further comprises:
(i) ploughing the slurry in a path from the drainage collection point to the slurry discharge point;
(ii) re-ploughing the slurry along the path of sub step (i) from the slurry discharge point to the drainage collection point;
(iii) repeating sub steps (i) and (ii) about one vehicle width from said path; and
(iv) repeating sub steps (i) to (iii) across each sub area.

5. The method of claim 1, wherein each sub area is ploughed at an even speed.

6. The method of claim 1, wherein step (d) is carried out for between about 24 hours to about 72 hours.

7. The method of claim 1, wherein step (b) further comprises placement of one or more markers in the sub areas, said markers indicating the target depth of slurry.

8. The method of claim 2, wherein step (b) further comprises constructing one or more guidance barriers adjacent the slurry discharge point, said guidance barriers being adapted to guide a discharge of slurry from the slurry discharge point.

9. The method of claim 1, wherein step (e) further comprises initially constructing one or more drainage barriers near the drainage collection point, said drainage barriers being adapted to collect run-off slurry and fluid released by the further consolidating of the deposited slurry.

10. The method of claim 9, wherein step (e) further comprises draining the fluid collected by the drainage barriers.

11. The method of claim 1 further comprising step (g) monitoring the one or more parameters of the settling pond and repeating steps (c) to (f) as required.

12. The method of claim 1, wherein a barrier with a height at least 120% the target depth of slurry at least partially extends around each sub area.

13. The method of claim 9, wherein each barrier is formed from dried slurry material.

14. The method of claim 10, wherein each barrier is formed from dried slurry material.

15. The method of claim 12, wherein each barrier is formed from dried slurry material.

16. A method to enhance the dewatering of a settling pond, said method including:
(a) identifying one or more parameters of the settling pond, said one or more parameters selected from a group including one or more of initial slurry density, target slurry density, initial depth of slurry, target depth of slurry, and regional climatology;
(b) preparing the settling pond by:
(i) nominally dividing the settling pond into one or more sub areas, each sub area having a slurry discharge point and a drainage collection point; and
(ii) constructing a barrier at least partially around each sub area;
(c) depositing a slurry into the sub areas to a depth equal to the target depth of slurry;
(d) allowing the slurry to consolidate under gravity and release fluid;
(e) further consolidating the slurry in each sub area with mechanical means;
(f) repeating step (e) periodically until the target slurry density is reached; and
(g) monitoring the one or more parameters of the settling pond and repeating steps (c) to (f) as required.

17. A method to improve the foundation of a portion of a settling pond by enhancing the dewatering of the portion of the settling pond, said method including:
(a) identifying one or more parameters of the portion of the settling pond in need of improved foundations including target slurry density;
(b) consolidating the portion with one or more mechanical means; and
(c) repeating step (b) until the target slurry density is reached.

18. The method of claim 17, wherein said mechanical means is a vehicle adapted to provide low ground pressure and plough material over which it traverses.

19. The method of claim 17, wherein step (b) further comprises:
(i) ploughing a path in the portion approximately 50 m in length, or as far as possible, in a direction approximately 45 degrees from an edge of the portion;
(ii) re-ploughing said path in the reverse direction;
(iii) repeating sub steps (i) and (ii) about one path width from the initial path; and
(iv) repeating sub steps (i) to (iii) along the edge.

20. The method of claim 19, wherein step (iii) further comprises re-ploughing the same paths from step (ii) thereby deepening previously ploughed paths and then, if target slurry density is not reached, splitting the previously ploughed paths by ploughing between the previously ploughed paths.

21. The method of claim 17, wherein slurry density is periodically monitored throughout steps (a) to (c).

22. A method to enhance the dewatering of a settling pond, said method including:
(a) identifying one or more parameters of the settling pond, said one or more parameters selected from a group including one or more of initial slurry density, target slurry density, initial depth of slurry, target depth of slurry, and regional climatology;
(b) preparing the settling pond by:
(i) nominally dividing the settling pond into one or more sub areas, each sub area having a slurry discharge point and a drainage collection point;
(ii) constructing a barrier at least partially around each sub area to a height at least 120% the target depth of slurry;
(iii) constructing one or more guidance barriers adjacent the slurry discharge point, said guidance barriers being adapted to guide a discharge of slurry from the slurry discharge point; and
(iv) placement of one or more markers in the sub areas, said markers indicating the target depth of slurry;
(c) depositing a slurry into the sub areas to a depth equal to the target depth of slurry;
(d) allowing the slurry to consolidate under gravity and release fluid for between about 24 hours to about 72 hours;
(e) further consolidating the slurry in each sub area with mechanical means adapted to provide low ground pressure, wherein said mechanical means is a vehicle adapted to plough the slurry, and wherein the slurry is further consolidated by:
(i) constructing one or more drainage barriers adjacent the drainage collection point, said drainage barrier being adapted to collect run-off slurry and fluid released from the slurry;
(ii) ploughing the slurry in a path from the drainage collection point to the slurry discharge point;
(iii) re-ploughing the slurry along said path from the slurry discharge point to the drainage collection point;
(iv) repeating sub steps (i) and (ii) about one vehicle width from said path; and
(v) repeating sub steps (i) to (iii) across each sub area; and
(vi) draining the fluid collected by the drainage barriers,
wherein each sub area is ploughed at an even speed;
(f) repeating step (e) periodically until the target slurry density is reached, wherein periodically is about every 2 to about 5 days; and
(g) monitoring the one or more parameters of the settling pond and repeating steps (c) to (f) as required.
